(19) United States
(12) Patent Application Publication
(10) Pub. No.: US 2026/0218847 A1
(43) Pub. Date: Jul. 30, 2026

(54) Mount for a laptop computer on a stationary bike

(71) Applicant: Daunte Lopez, Brentwood, CA (US)

(72) Inventor: Daunte Lopez, Brentwood, CA (US)

(21) Appl. No.: 19/456,341

(22) Filed: Jan. 22, 2026

Related U.S. Application Data
(60) Provisional application No. 63/749,838, filed on Jan. 27, 2025.

(51) Int. Cl. F16M 13/02; B62J 11/00; F16M 11/10; F16M 11/20

(52) U.S. Cl. CPC F16M 13/02; B62J 11/00; F16M 11/10; F16M 11/2021

(57) ABSTRACT

A mount for a laptop computer on a stationary bike, comprising: a left bar clamp and a right bar clamp; wherein the left bar clamp and right bar clamp attach to handlebars on a stationary bike; wherein the mount is made of high-strength composite material; wherein the mount is adjustable in regards to changing size to fit different electronic devices; wherein the mount has a platform that can hold electronic devices; wherein the platform can move horizontally; wherein the platform can adjust its width; wherein the mount can change angles so as to be easy to view by a user; wherein the mount may be secured to either road or mountain bike handlebars; and wherein the platform can be tightened on an electronic device so as to hold the electronic device such that the electronic device does not fall while a user rides on the stationary bike.

### FIELD OF THE INVENTION

The present invention relates to a mount for a laptop computer on a stationary bike.

### BACKGROUND

The background description includes information that may be useful in understanding the present invention. It is not an admission that any of the information provided herein is prior art or relevant to the presently claimed invention, or that any publication specifically or implicitly referenced is prior art.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply. The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients or properties such as concentration, reaction conditions, and so forth, used to describe and claim certain embodiments of the invention are to be understood as being modified in some instances by the term “about.”

Accordingly, in some embodiments, the numerical parameters set forth in the written description and attached claims are approximations that can vary depending upon the desired properties sought to be obtained by a particular embodiment.

In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meanings of “a,” “an,” and “the” include plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed.

No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Nearly 1 in 3 adults (30.7%) are overweight. Fryar CD, Carroll MD, Afful J. Prevalence of overweight, obesity, and severe obesity among adults aged 20 and over: United States, 1960-1962 through 2017-2018. NCHS Health E-Stats, Centers for Disease Control and Prevention. 2020. Updated Feb. 8, 2021. Accessed Jan. 29, 2021. www.cdc.gov/nchs/data/hestat/obesity-adult-17-18/obesity-adult.htm External link

https://www.niddk.nih.gov/health-information/health-statistics/overweight-obesity “Three-Quarters of U.S. Adults Are Now Overweight or Obese”.

https://www.nytimes.com/2024/11/14/well/obesity-epidemic-america.html, Nov. 14, 2024. This indicates that Americans need to lose weight.

Since the pandemic there has been a huge rise in the number of people working from home. These people work on their laptop computer using the internet, and so have no need to commute to work. People are also more sedentary than ever, they get things delivered to them, and without a need for exercise, many do not exercise. Therefore, there is a huge population of people working from home on their laptop computers, who are sedentary.

This is a huge problem, considering the health problems that being sedentary results in, such as diabetes, heart disease and obesity.

### SUMMARY

The present invention solves these issues, because the present invention provides a means for a person working at home on their laptop computer to exercise at the same time. The person uses the present invention to mount their laptop computer on their stationary bike, and rides the stationary bike while working on the laptop computer. This allows the person to both fulfill their work obligations as well as exercise, improving their health by not being sedentary.

A unique feature of the present invention is its adjustable mounting system, which offers a level of flexibility not found in existing mounts for laptops/tablets/smartphones on bikes. Measurements of the present invention are designed to be more accurate, ensuring a secure fit regardless of device size. Capacity to expand both horizontally and vertically fills a gap, because such a capability was not present in other products currently available.

The mount is made of a high-strength composite material, which is more durable than typical plastic used in other mounts. The ability to change the angle is a significant improvement, providing users with a customizable viewing experience. The mount can be secured to either road or mountain bike handlebars. The mount provides stability during use, is hands-free, and has near universal compatibility with laptop computers, tablets and smartphones.

The outside of the mount can have a skin with different appearances and colors if the user is so interested.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

Many aspects of the present disclosure can be better understood with reference to the attached drawings. The components in the drawings are not necessarily drawn to scale, with emphasis instead being placed upon clearly illustrating the principles of the disclosure. Moreover, in the drawings, like reference numerals designate corresponding parts throughout several views.

FIG. 1 is a drawing of a mount for a laptop computer for a stationary bike according to various embodiments of the present disclosure.

FIG. 2 is a drawing of a mount for a laptop computer for a stationary bike according to various embodiments of the present disclosure.

FIG. 3 is a drawing of a mount for a laptop computer for a stationary bike according to various embodiments of the present disclosure.

FIG. 4 is a drawing of a mount for a laptop computer for a stationary bike according to various embodiments of the present disclosure.

FIG. 5 is a drawing of a mount for a laptop computer for a stationary bike according to various embodiments of the present disclosure.

FIG. 6 is a drawing of a mount for a laptop computer for a stationary bike according to various embodiments of the present disclosure.

FIG. 7 is a drawing of a mount for a laptop computer for a stationary bike according to various embodiments of the present disclosure.

FIG. 8 is a drawing of a mount for a laptop computer for a stationary bike according to various embodiments of the present disclosure.

FIG. 9 is a drawing of a mount for a laptop computer for a stationary bike according to various embodiments of the present disclosure.

FIG. 10 is a drawing of parts of one embodiment of the present disclosure.

FIG. 11 is a drawing of a mount for a laptop computer for a stationary bike according to various embodiments of the present disclosure.

FIG. 12 is a drawing of a mount for a laptop computer for a stationary bike according to various embodiments of the present disclosure.

FIG. 13 is a drawing of a mount for a laptop computer for a stationary bike according to various embodiments of the present disclosure.

FIG. 14 is a drawing of a mount for a laptop computer for a stationary bike according to various embodiments of the present disclosure.

FIG. 15 is a drawing of a mount for a laptop computer for a stationary bike according to various embodiments of the present disclosure.

FIG. 16 is a drawing of a mount for a laptop computer for a stationary bike according to various embodiments of the present disclosure.

FIG. 17 is a drawing of parts of one embodiment of the present invention.

FIG. 18 discloses parts of one embodiment of the present invention.

FIG. 19 discloses parts of one embodiment of the present invention.

FIG. 20 is a drawing of a mount for a laptop computer for a stationary bike according to various embodiments of the present disclosure.

FIG. 21 is a drawing of a mount for a laptop computer for a stationary bike according to various embodiments of the present disclosure.

FIG. 22 is a drawing of a mount for a laptop computer for a stationary bike according to various embodiments of the present disclosure.

FIG. 23 is a drawing of a mount for a laptop computer for a stationary bike according to various embodiments of the present disclosure.

FIG. 24 is a drawing of a mount for a laptop computer for a stationary bike according to various embodiments of the present disclosure.

FIG. 25 is a drawing of a mount for a laptop computer for a stationary bike according to various embodiments of the present disclosure.

FIG. 26 is a drawing of a mount for a laptop computer for a stationary bike according to various embodiments of the present disclosure.

FIG. 27 is a drawing of a mount for a laptop computer for a stationary bike according to various embodiments of the present disclosure.

FIG. 28 is a drawing of a mount for a laptop computer for a stationary bike according to various embodiments of the present disclosure.

FIG. 29 is a drawing of a mount for a laptop computer for a stationary bike according to various embodiments of the present disclosure.

FIG. 30 is a drawing of a mount for a laptop computer for a stationary bike according to various embodiments of the present disclosure.

FIG. 31 is a drawing of a mount for a laptop computer for a stationary bike according to various embodiments of the present disclosure.

FIG. 32 is a drawing of part of one embodiment of the present invention.

FIG. 33 displays a part of one embodiment of the present invention.

FIG. 34 displays a part of one embodiment of the present invention.

FIG. 35 displays a part of one embodiment of the present invention.

FIG. 36 displays a part of one embodiment of the present invention.

FIG. 37 displays a part of one embodiment of the present invention.

FIG. 38 displays a part of one embodiment of the present invention.

FIG. 39 displays part of one embodiment of the present invention.

FIG. 40 displays part of one embodiment of the present invention.

FIG. 41 displays part of one embodiment of the present invention.

FIG. 42 displays part of one embodiment of the present invention.

FIG. 43 displays a part of one embodiment of the present invention.

FIG. 44 displays a part of one embodiment of the present invention.

FIG. 45 displays a part of one embodiment of the present invention.

FIG. 46 displays a part of one embodiment of the present invention.

FIG. 47 displays a part of one embodiment of the present invention.

### DETAILED DESCRIPTION

Various embodiments of the present disclosure relate to providing a mount for a laptop computer for a stationary bike.

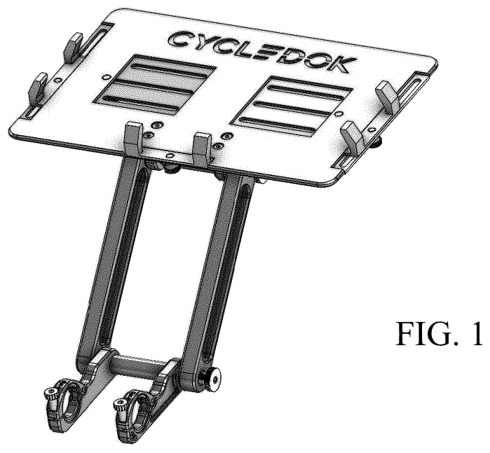

FIG. 1 discloses one embodiment of the present invention, wherein the mount is shaped so as to hold a tablet or smartphone. The mount attaches to the handlebars of a stationary bike, and then also attaches to the tablet or smartphone, so that even while a user is riding the bike, the tablet or smartphone doesn't move, and the user can read and type on the tablet or smartphone.

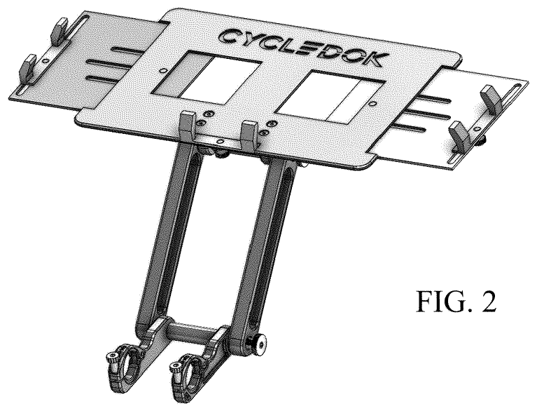

FIG. 2 discloses one embodiment of the present invention, wherein the mount is shaped so as to hold a tablet or smartphone. The mount is flexible horizontally, so that it can accommodate different size tablets or smartphones because it moves horizontally and can stop at the width of the tablet or smartphone. The mount attaches to the handlebars of a stationary bike, and then also attaches to the tablet or smartphone, so that even while a user is riding the bike, the tablet or smartphone doesn't move, and the user can read and type on the tablet or smartphone.

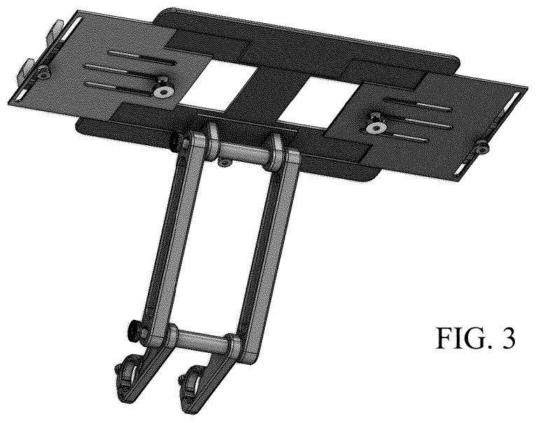

FIG. 3 is a back view of the mount from FIG. 2.

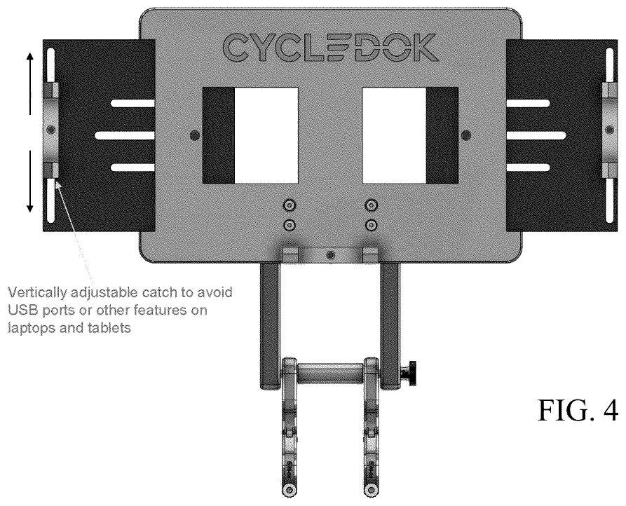

FIG. 4 discloses one embodiment of the present invention, wherein the mount is shaped so as to hold a tablet or smartphone. The mount is flexible horizontally, so that it can accommodate different size tablets or smartphones because it moves horizontally and can stop at the width of the tablet or smartphone. The mount is also flexible vertically, so that it can accommodate different size tablets or smartphones because there is a vertically adjustable catch that can stop at the height of the tablet or smartphone. This vertically adjustable catch avoids USB ports or other ports on tablets and smartphones. The mount attaches to the handlebars of a stationary bike, and then also attaches to the tablet or smartphone, so that even while a user is riding the bike, the tablet or smartphone doesn't move, and the user can read and type on the tablet or smartphone.

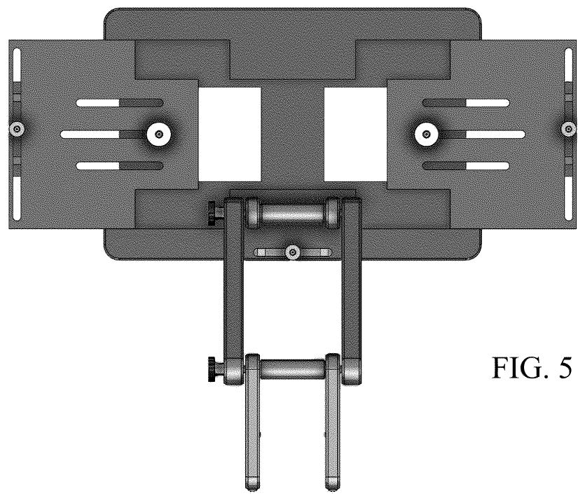

FIG. 5 discloses another version of the mount in FIG. 4.

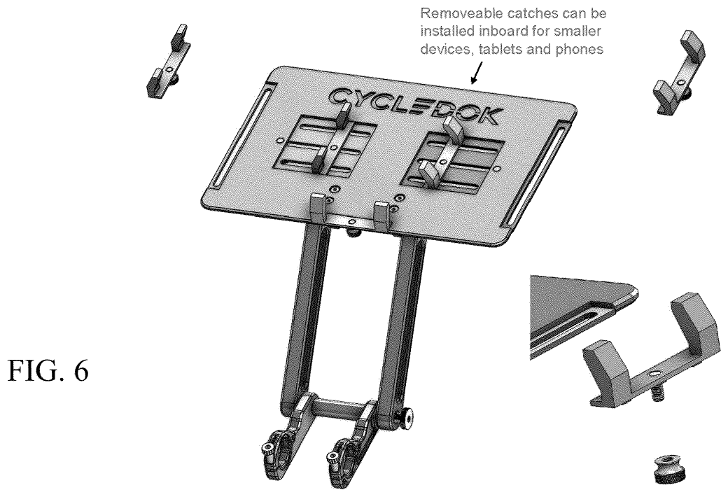

FIG. 6 discloses one embodiment of the present invention, wherein the mount is shaped so as to hold a tablet or smartphone. The mount includes removable catches that can be installed onboard the mount so as to accommodate smaller devices, tablets and smartphones. The mount attaches to the handlebars of a stationary bike, and then also attaches to the tablet or smartphone, so that even while a user is riding the bike, the tablet or smartphone doesn't move, and the user can read and type on the tablet or smartphone.

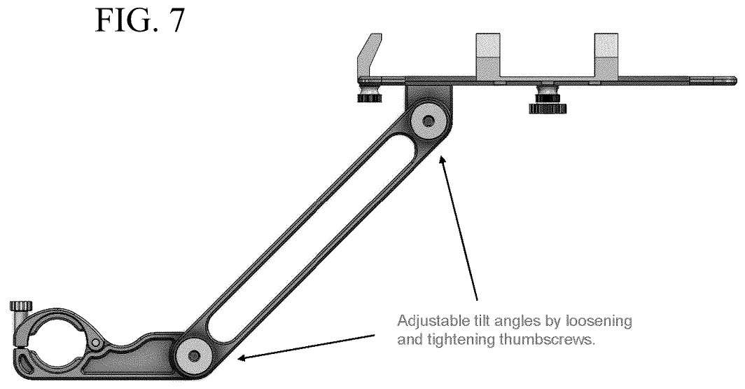

FIG. 7 discloses one embodiment of the present invention, wherein the mount can hold a laptop computer. The mount can be adjusted in terms of tilt and angle by loosening and tightening thumbscrews. This allows a user to view their laptop computer at different angles, which might be more convenient.

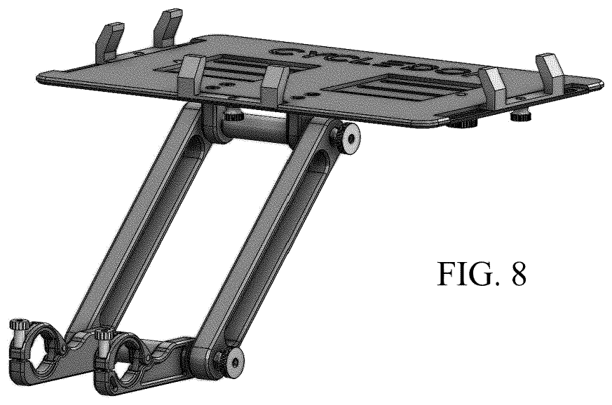

FIG. 8 discloses one embodiment of the present invention, wherein the mount can hold a laptop computer. The mount can be adjusted in terms of tilt and angle by loosening and tightening thumbscrews. This allows a user to view their laptop computer at different angles, which might be more convenient. The mount is flexible horizontally, so that it can accommodate different size laptop computers because it moves horizontally and can stop at the width of the tablet or smartphone. The mount is also flexible vertically, so that it can accommodate different size laptop computers because there is a vertically adjustable catch that can stop at the height of the tablet or smartphone.

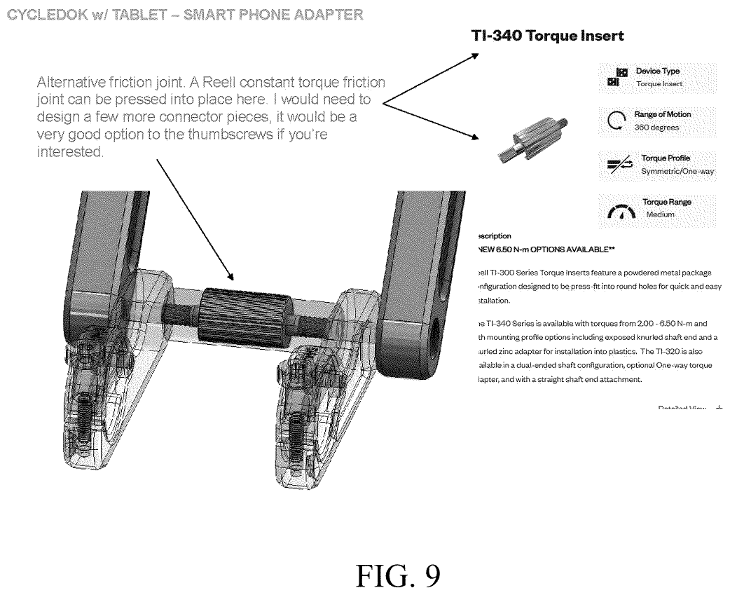

FIG. 9 discloses one embodiment of the present invention, wherein the mount can hold a smartphone or tablet. This mount includes an alternative friction joint. This alternative friction joint is a constant torque friction joint pressed into place in the center of the lower horizontal bar. It connects to the rest of the mount with additional connector pieces. This joint helps the mount handle high levels of torque which might be placed on the mount by a user who is pushing the mount while cycling on their stationary bike.

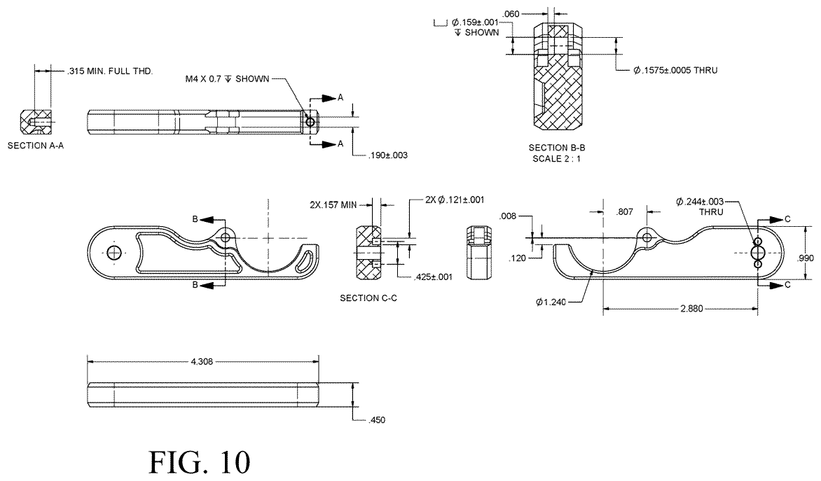

FIG. 10 discloses a bar clamp, which can be part of one embodiment of the present invention. The bar clamp holds the mount onto the stationary bike. The various measurements and designs shown in FIG. 10 are the optimal measurements and design for a bar clamp in order to hold a laptop computer on a mount on a stationary bike.

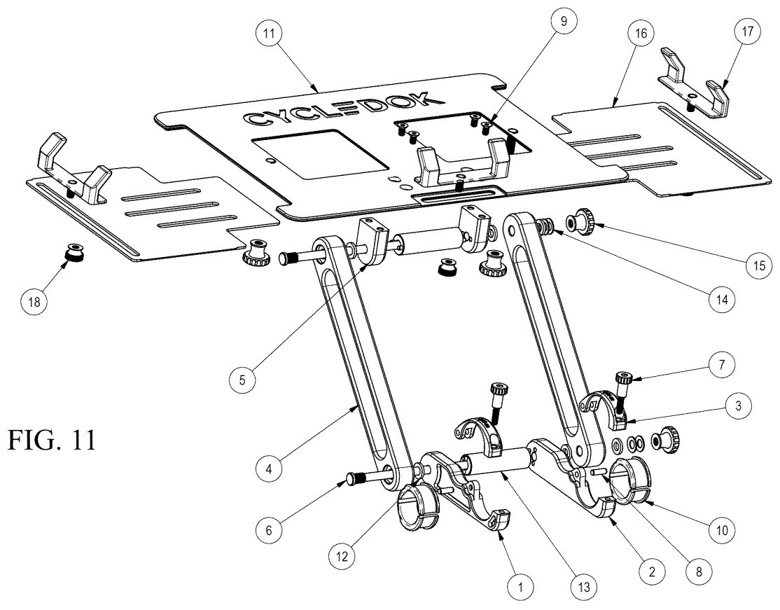

FIG. 11 discloses one embodiment of the present invention, including an exploded view of every part of the mount. These different parts include part 1, a BAR_CLAMP_LEFT, part 2, a BAR_CLAMP_RIGHT, part 3, a BAR_CLAMP_TOP, part 4, a PIVOT_ARM, part 5, a PIVOT_MOUNT, part 6, a PIVOT_AXLE, part 7, a CLAMP_SCREW, part 8, a DOWEL PIN that is 4 MM OD×12 MM L, part 9 FHSHCS, M4×8, 2.5 MM HEX, part 10 ADAPTER_254, part 11 PLATFORM, part 12 18-8 Stainless Steel Washer, part 13 SPACER, part 14 Belleville Disc Spring, part 15 THUMB SCREW, part 16 WING, part 17 KEEPER and part 18 Flanged Knurled-Head Thumb Nut.

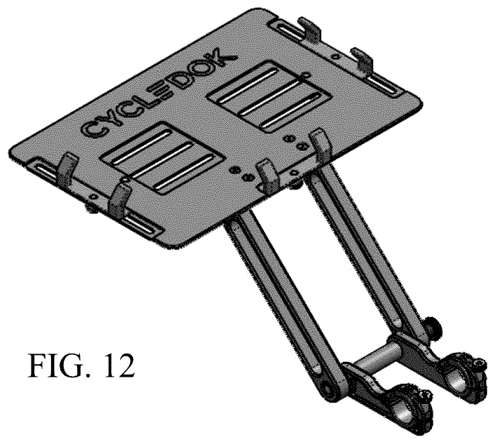

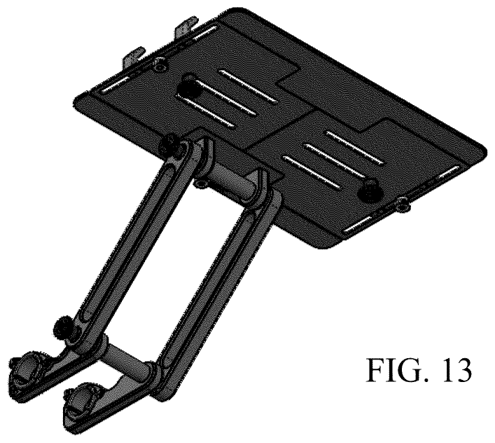

FIGS. 12-15 disclose different angles of FIG. 11.

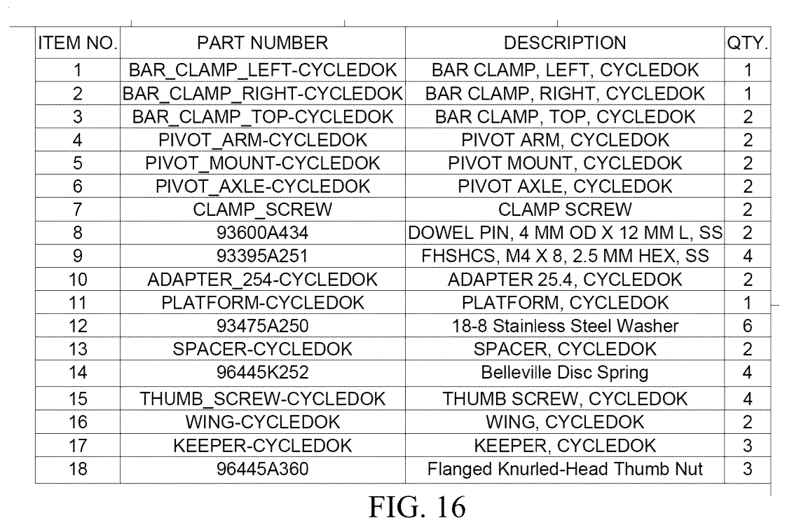

FIG. 16 discloses the various parts of FIG. 11.

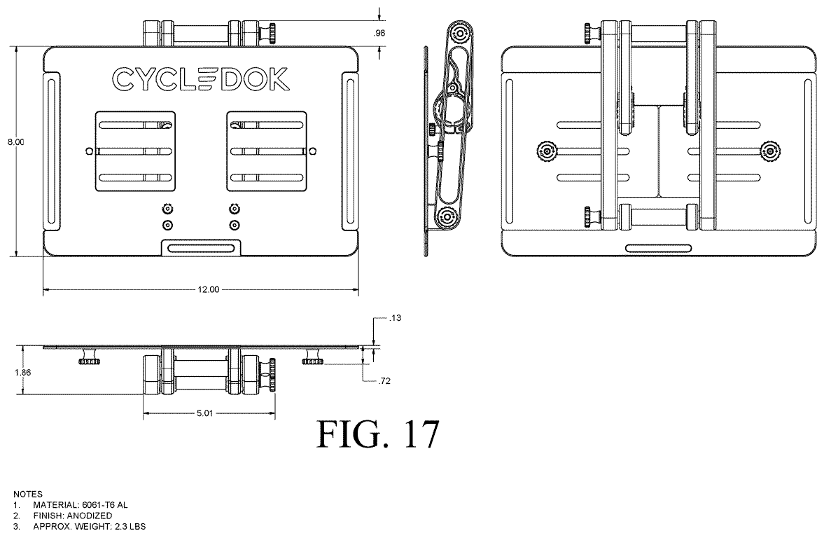

FIG. 17 discloses packaging for the present invention.

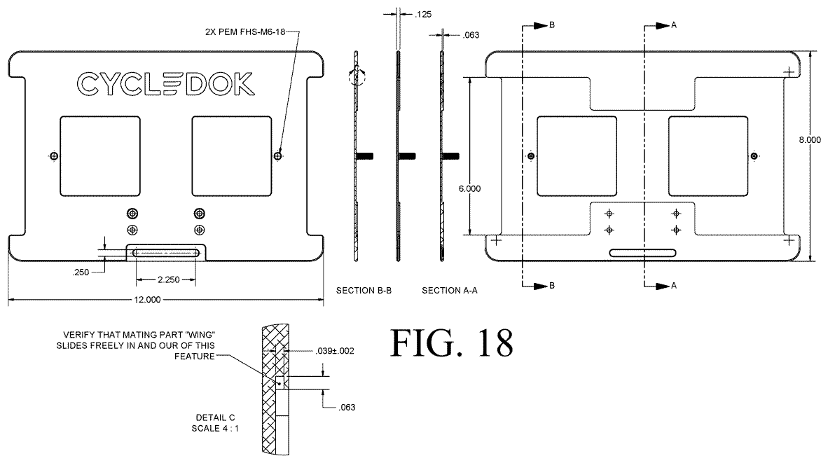

FIG. 18 discloses one embodiment of the present invention. It discloses measurements and diagrams of surface, or platform, of the mount. These measurements can be optimal for certain laptop computers or smartphones or tablets that may be placed on the mount.

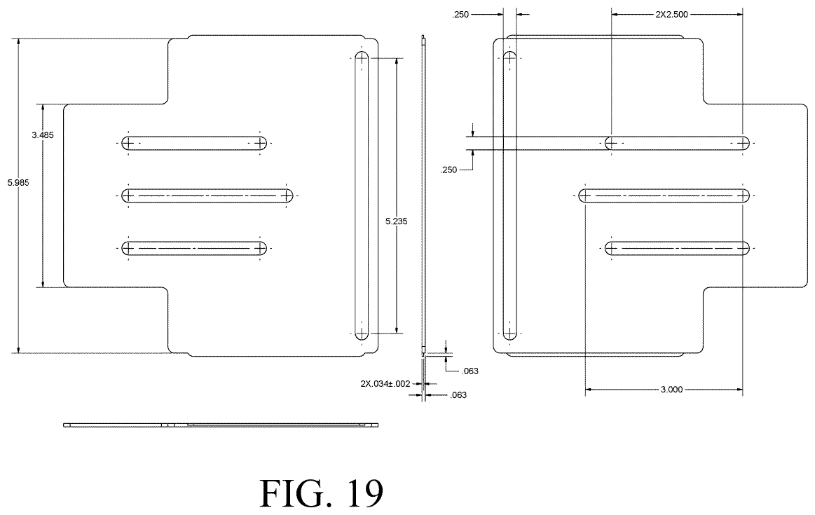

FIG. 19 discloses one embodiment of the present invention. It discloses measurements and diagrams of horizontally expanding sides, or wings, of the platform. These measurements can be optimal for certain laptop computers or smartphones or tablets that may be placed on the mount.

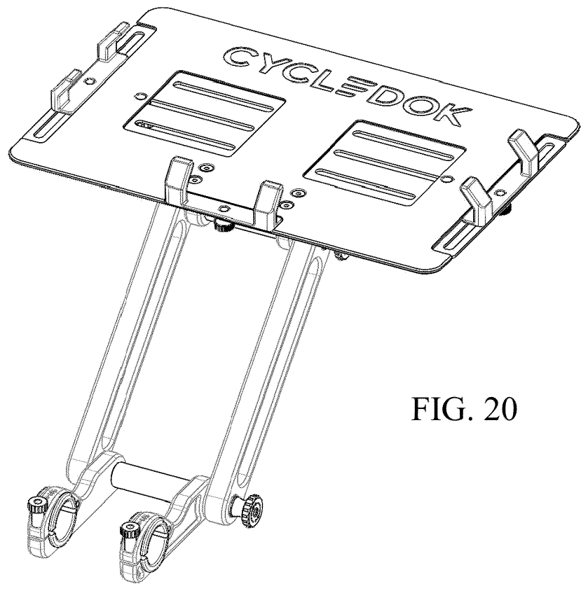

FIG. 20 discloses one embodiment of the present invention, wherein the mount is shaped so as to hold a laptop computer or tablet or smartphone. The mount is flexible horizontally, so that it can accommodate different size laptop computers or tablets or smartphones because it moves horizontally and can stop at the width of the laptop computer or tablet or smartphone. The mount attaches to the handlebars of a stationary bike, and then also attaches to the laptop computer or tablet or smartphone, so that even while a user is riding the bike, the laptop computer or tablet or smartphone doesn't move, and the user can read and type on the laptop computer or tablet or smartphone.

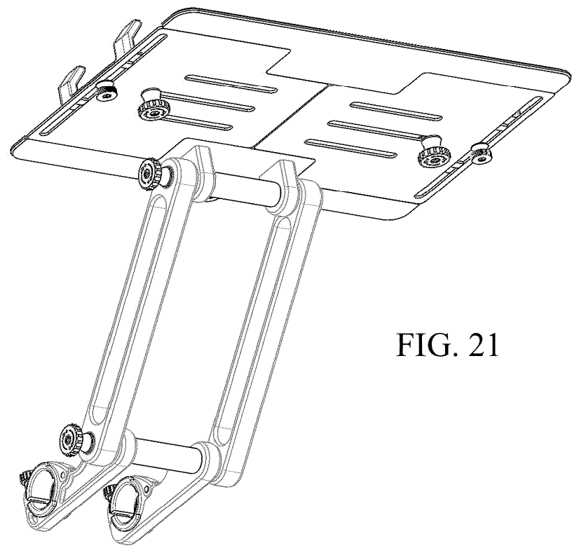

FIG. 21 discloses another view of FIG. 20.

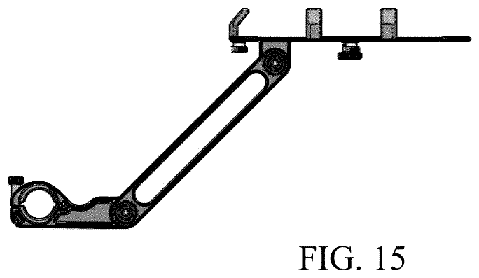

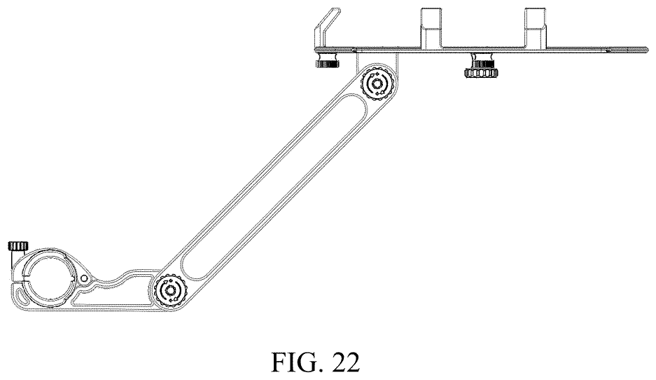

FIG. 22 discloses another view of FIG. 15.

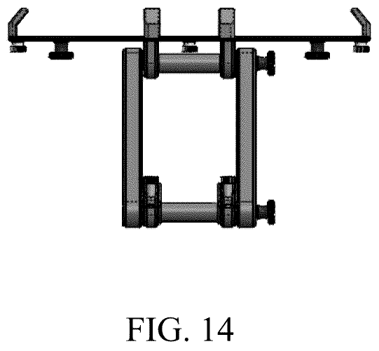

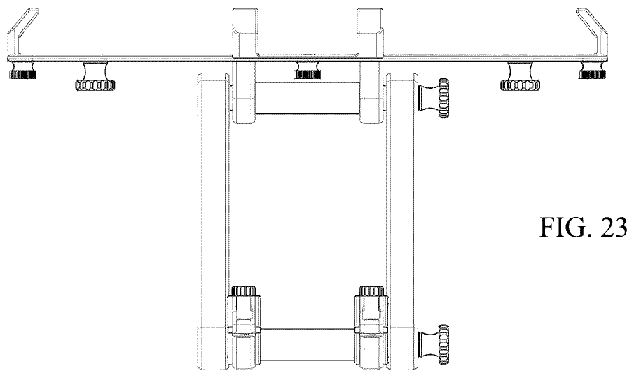

FIG. 23 discloses another view of FIG. 14.

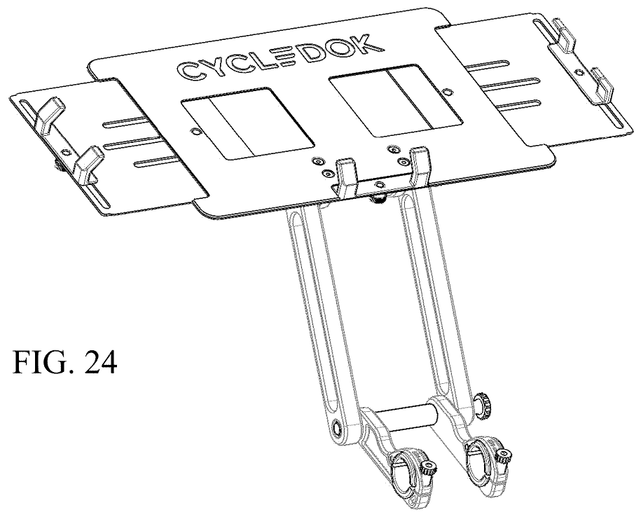

FIG. 24 discloses another view of FIG. 2.

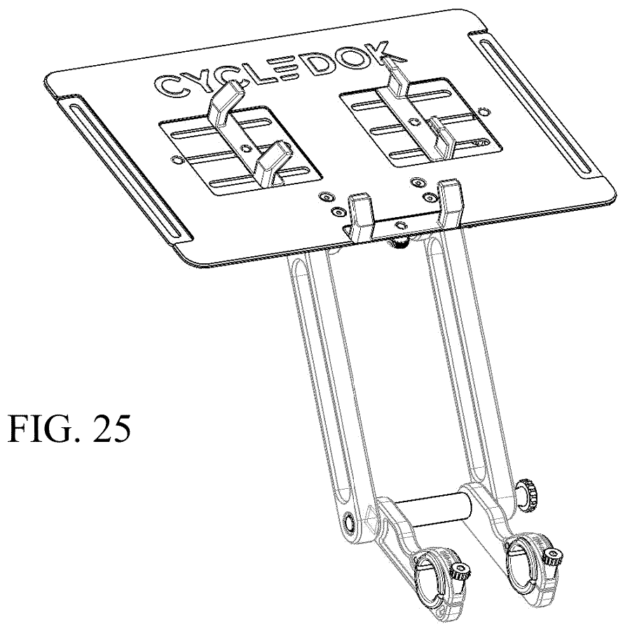

FIG. 25 discloses another view of FIG. 12.

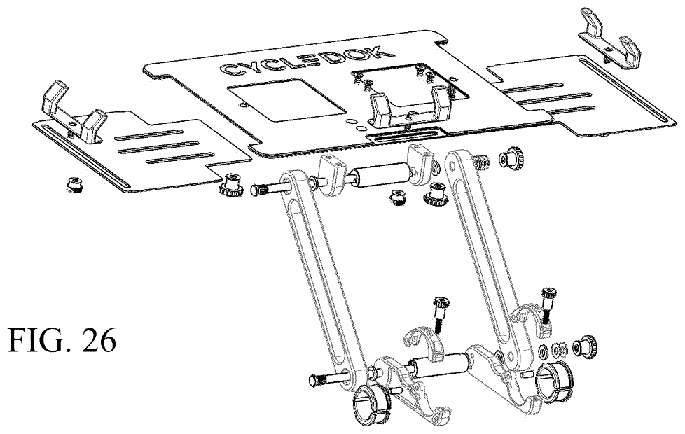

FIG. 26 discloses another view of FIG. 11.

Anodized aluminum is aluminum that has undergone an electrochemical process to create a protective, durable, and decorative oxide layer on its surface. This process enhances its natural resistance to corrosion, abrasion, and fading, making it ideal for a wide range of applications from building exteriors and appliances to aerospace components. The resulting finish is non-toxic, long-lasting, and can be colored in various shades.

In one embodiment of the invention, the mount has 3 clamps, 3 pivots, 1 adapter, 1 spacer, 1 thumb, 1 keeper, 1 platform and 1 grommet hex driver

In another embodiment of the invention, 2 bar clamps secure the mount to the handlebars of the stationary bike. The 2 bar clamps connect the handlebars with the pivot arms. The third bar clamp does the same thing, but can be loosened or tightened to the handlebars of the stationary bike depending on the user's preference. The two pivot arms connect the bar clamps to the tray, and allow for movement vertically so that the user can customize how they view the platform. 19 and 20 are tools in a toolkit to adjust the various parts of the mount. This allows the user to move the mount and lock various parts of the mount in place in a position that the user prefers. Alternatively, there are tabs connecting the bar clamp and pivot arms, wherein the tabs can be loosened or tightened by moving the tabs back and forth. The clamp screw secures the top bar clamp from the top to the handlebars, and can be completely removed.

A Dowel pin goes through a top of the bar clamp and allows the top of the bar clamp to move up and down. A user removes the dowel pin, moves the bar clamp to the preferred location, and reinserts the dowel pin to lock the bar clamp. The screw secures the tray to the mount that is located at the top of the vertical bars. The screws are secured to the pivot arms. There are 4 screws. In alternate embodiments, there can be any number of screws, including zero. The adapter is an inner cover of the bar clamp that allows a user to secure the mount to a smaller diameter set of handlebars. This removes the need to make 2 different types of clamps. The adapter can be made of plastic. There is a trend of handlebars getting thinner, so this inner cover takes care of connecting to those smaller handlebars. The inner cover can optionally be screwed in.

There should be some friction so that movement of each joint is not completely free. These are friction joints that prevent each move from moving once a user puts it in place. There is a certain amount of built-in torque.

The spacer is a cylinder that connects the 2 bar clamps, and a screw goes through the whole cylinder as in a shaft. There is another cylinder/shaft below the tray connecting both pivot arms. The 13 thumbscrew loosens the horizontally moving catch so that a user can securely connect a wider laptop to the mount. It widens the platform to accept a wider laptop or tablet or electronic device. The openings on the platform allow an electronic device on the platform to vent heat. 17 hex nut secures pivot arm to upper cylinder/shaft. A screw goes through the cylinder/shaft that can be removed.

The measurements in figures are in inches, and are only representative of one embodiment of the invention. Larger or smaller sizes are possible as other embodiments of the invention. Another embodiment of the present invention includes all variations of the mount such that there is no vertical catch and no horizontal catch. This would be useful in case the user always wants a flat platform. Another embodiment of the present invention includes all variations of the mount such that a sticky substance is used to attach electronic devices to the platform. One such sticky substance could be rubber, but others may be used. This would serve as an alternative to horizontal or vertical catches, in case the user wanted to tilt the platform without catches, and didn't want the electronic device to fall off.

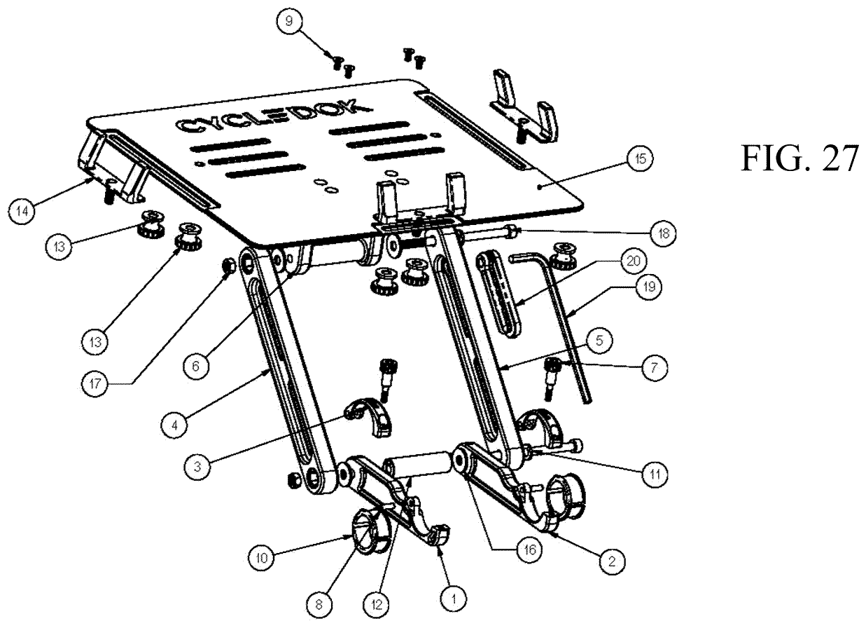

FIG. 27 displays one embodiment of the present invention. Various parts in FIG. 27 include: BAR CLAMP LEFT 1, BAR_CLAMP_RIGHT 2, BAR CLAMP TOP 3, PIVOT_ARM-LEFT 4, PIVOT_ARM-RIGHT 5, PIVOT_MOUNT 6, CLAMP_SCREW 7, DOWEL PIN 8, hex 9, ADAPTER 10, FLAT WASHER 11, SPACER 12, THUMB_SCREW 13, KEEPER 14, PLATFORM SUBASSY 15, FLAT WASHER 16, Stainless Steel Hex Nut 17, Stainless Steel Socket Head Screw 18, High-Visibility Gold Hex L-Key 19 and GROMMET-HEX-DRIVER 20. The BAR CLAMP LEFT 1 and BAR CLAMP RIGHT 2 attached to handlebars of a stationary bike. The BAR_CLAMP TOP 3 attaches to a top of the handlebars of the stationary bike. The PIVOT_ARM-LEFT 4 and PIVOT ARM-RIGHT 5 connect from the bar clamps to the platform, as well as to the PIVOT MOUNT 6. The CLAMP SCREW 7 tightens the bar clamps. The Dowel pin 8 allows for a connection to smaller size handlebars on a stationary bike. The hex 9 secures the platform. The adapter 10 is an inner cover of the bar clamp that allows a user to secure the mount to a smaller diameter set of handlebars. The flat washer 11 is a washer. The spacer 12 is a cylinder that connects the 2 bar clamps, and a screw goes through the whole cylinder as in a shaft. The thumbscrew 13 loosens the horizontally moving catch so that a user can securely connect a wider laptop to the mount. It widens the platform to accept a wider laptop or tablet or electronic device. The openings on the platform allow an electronic device on the platform to vent heat. The keeper 14 is a guard rail that secures objects in place on the platform.

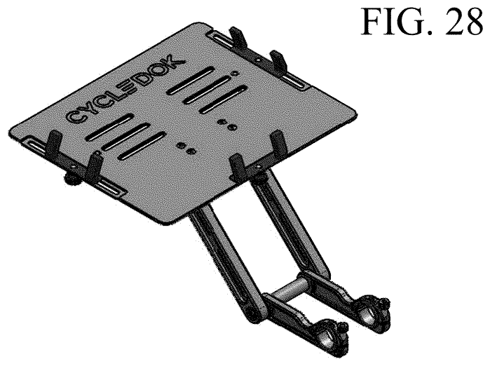

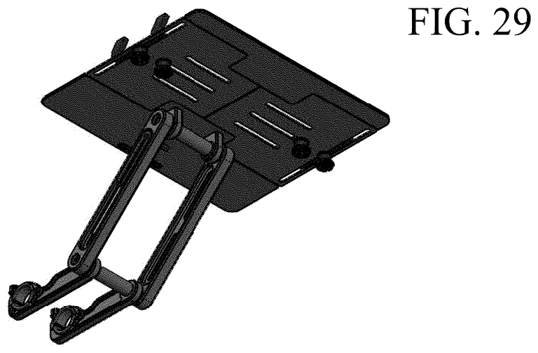

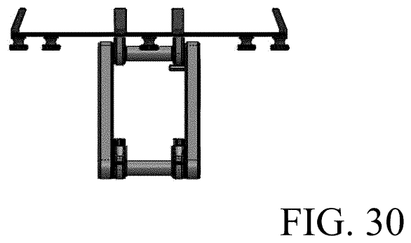

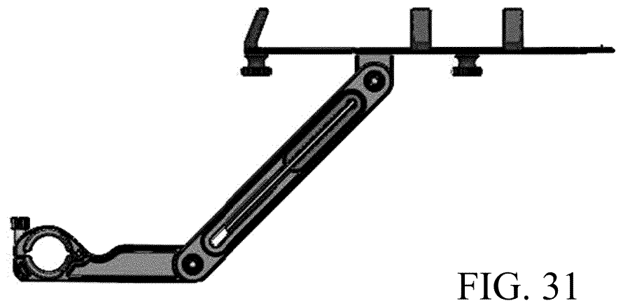

FIG. 28 displays another embodiment and another angle of the present invention. FIG. 29 displays another embodiment and another angle of the present invention. FIG. 30 displays another embodiment and another angle of the present invention. FIG. 31 displays another embodiment and another angle of the present invention.

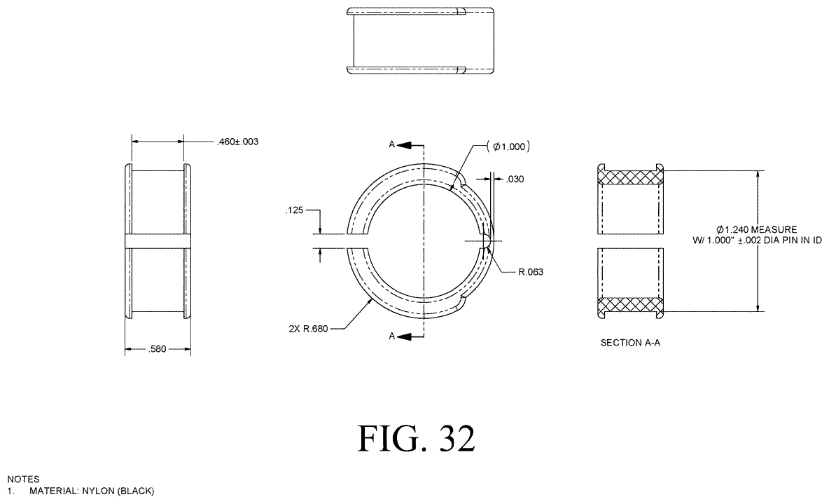

FIG. 32 displays an adapter that is part of one embodiment of the present invention. The adapter is an inner cover of the bar clamp that allows a user to secure the mount to a smaller diameter set of handlebars. This removes the need to make 2 different types of clamps. The adapter can be made of plastic or nylon. Measurements in all figures are optional embodiments, and alternative measurements can be utilized.

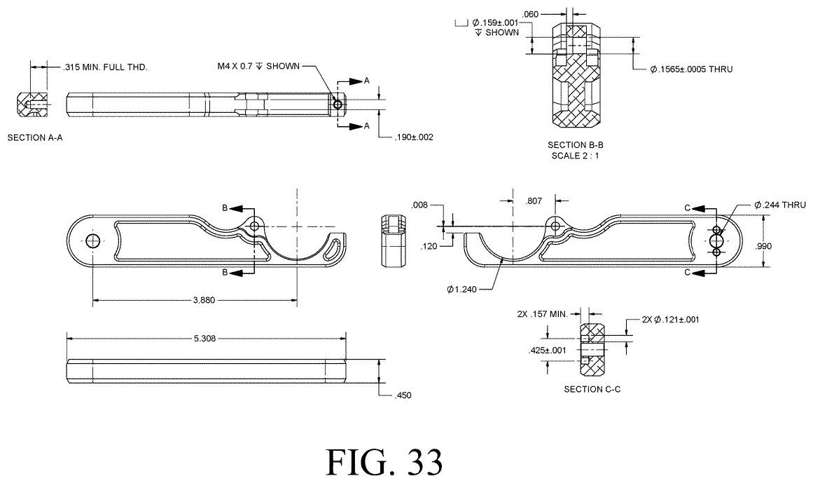

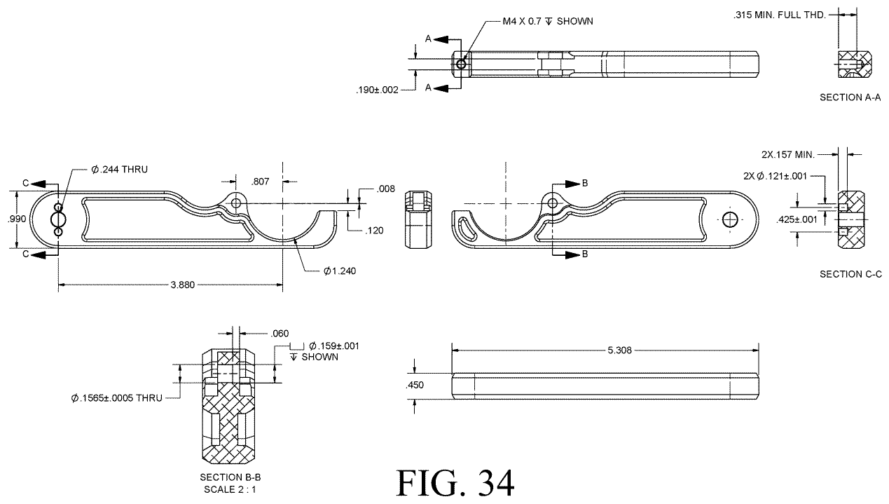

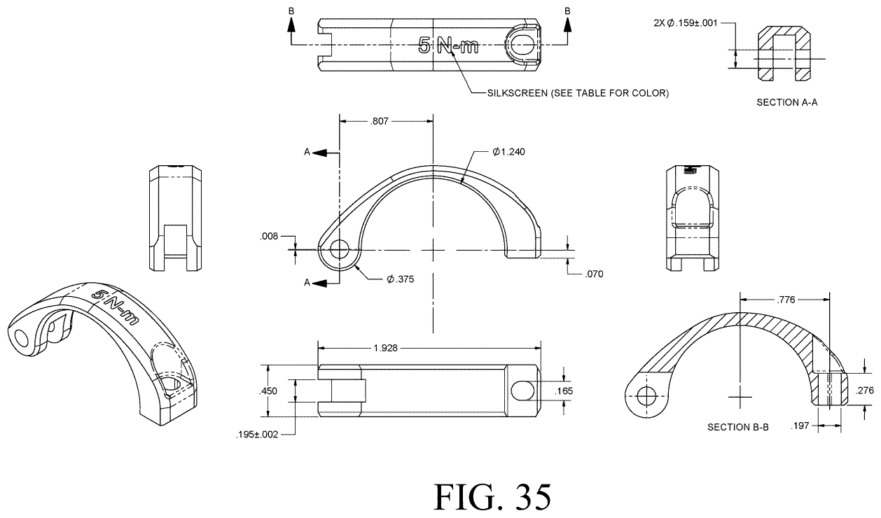

FIG. 33 displays a left bar clamp that is part of one embodiment of the present invention. FIG. 34 displays a right bar clamp that is part of one embodiment of the present invention. The left bar clamp and right bar clamp secure the mount to the handlebars of the stationary bike. The 2 bar clamps connect the handlebars with the pivot arms. FIG. 35 displays a top bar clamp that is part of one embodiment of the present invention. The top bar clamp also secures the mount to the handlebars of the stationary bike, but can be loosened or tightened to the handlebars of the stationary bike depending on the user's preference.

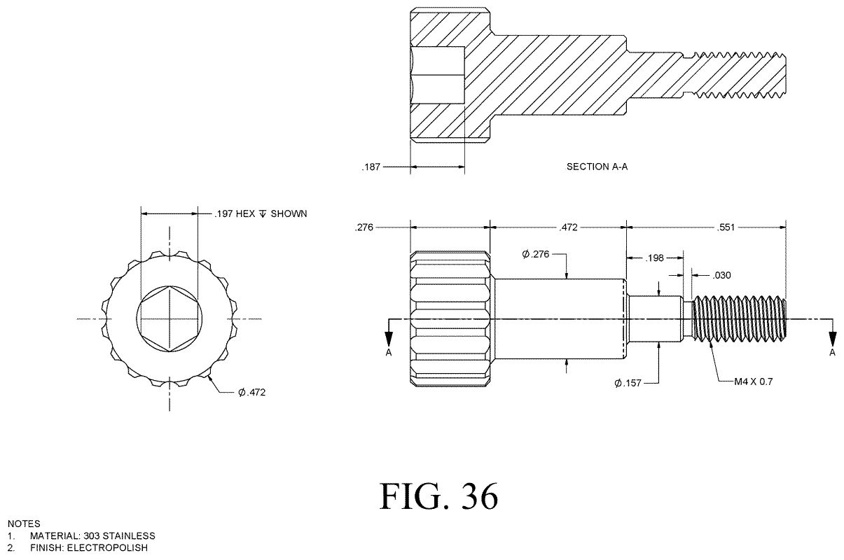

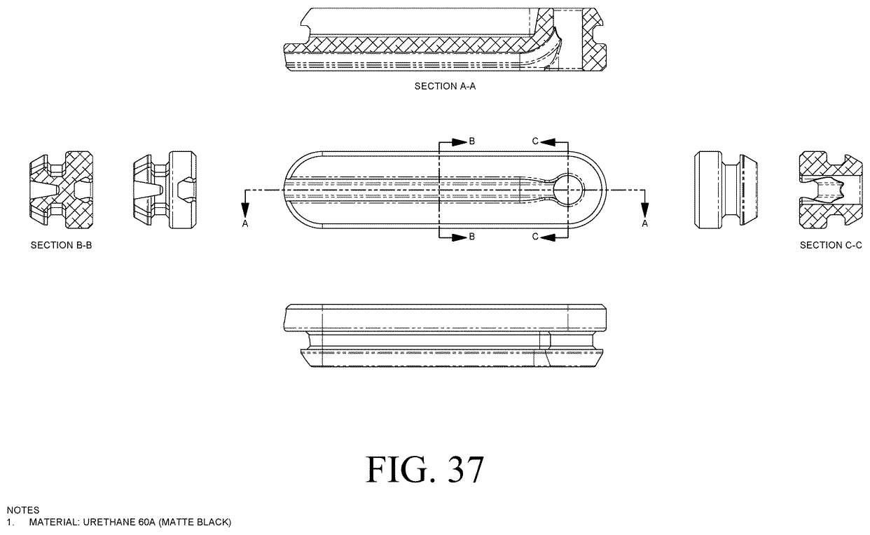

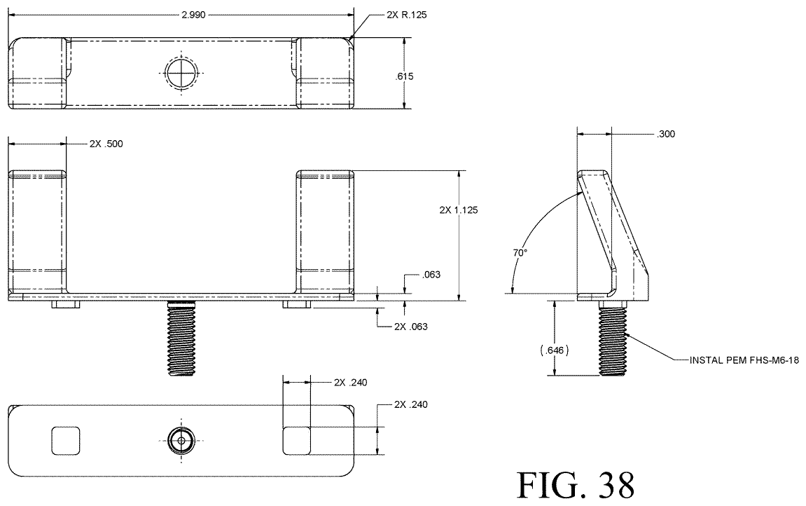

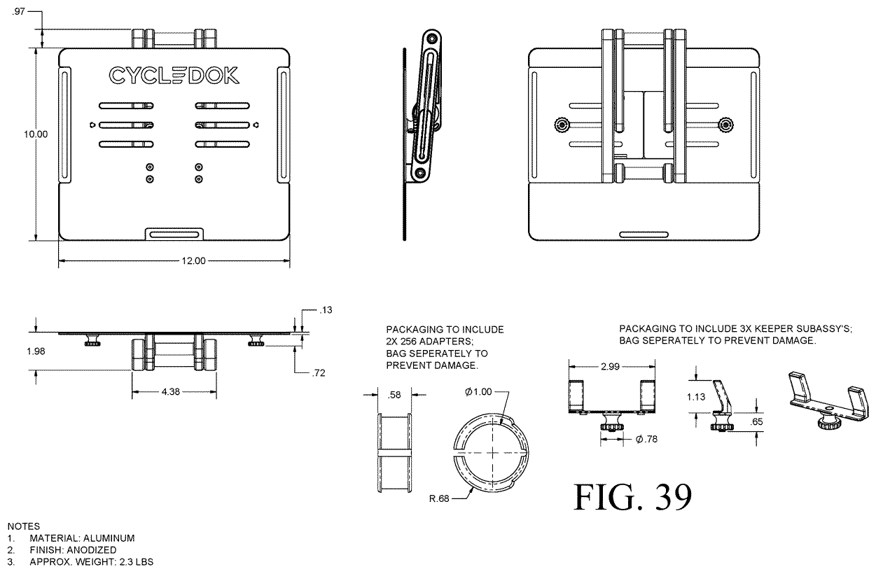

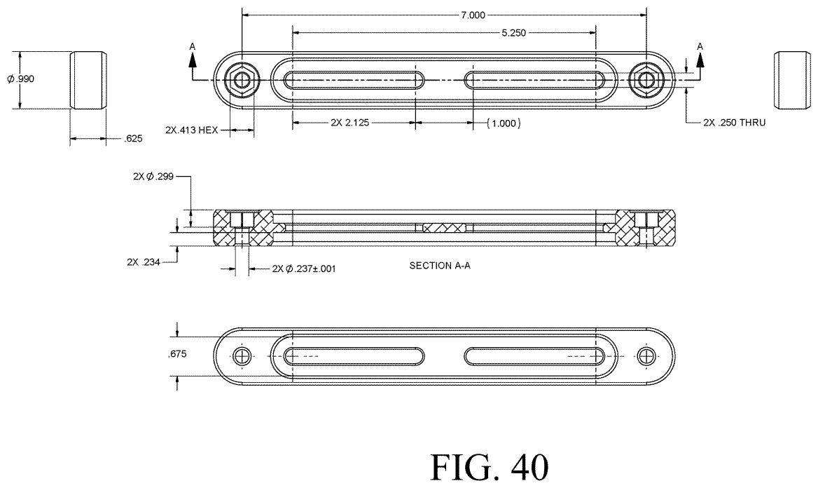

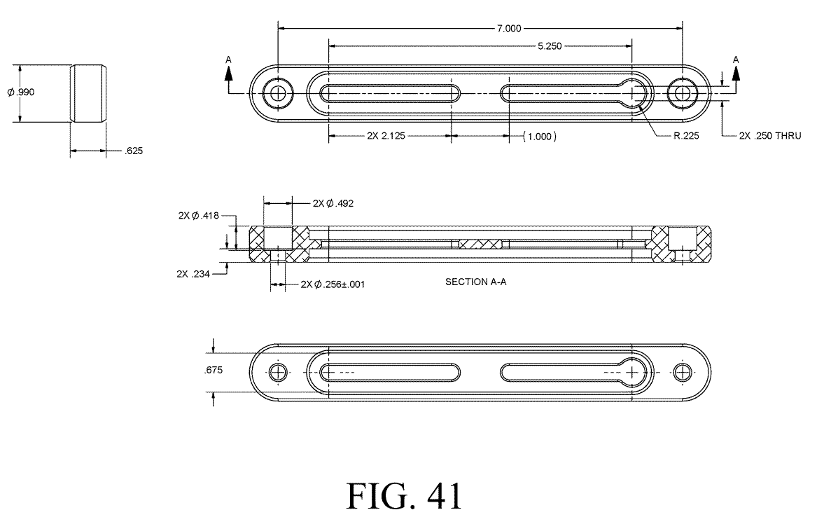

FIG. 36 displays a clamp screw that is part of one embodiment of the present invention. The clamp screw secures the top bar clamp from the top to the handlebars, and can be completely removed. FIG. 37 displays a grommet hex driver that is part of one embodiment of the present invention. The grommet hex driver is a rubber insert placed within the right pivot arm to secure a Gold Hex L-Key. FIG. 38 displays a keeper that is part of one embodiment of the present invention. The keeper is a guard rail that secures objects in place on the platform. FIG. 39 displays packaging that is part of one embodiment of the present invention. FIG. 40 displays a left pivot arm that is part of one embodiment of the present invention. FIG. 41 displays a right pivot arm that is part of one embodiment of the present invention. The left pivot arm and right pivot arm connect the bar clamps to the tray, and allow for movement vertically so that the user can customize how they view the platform.

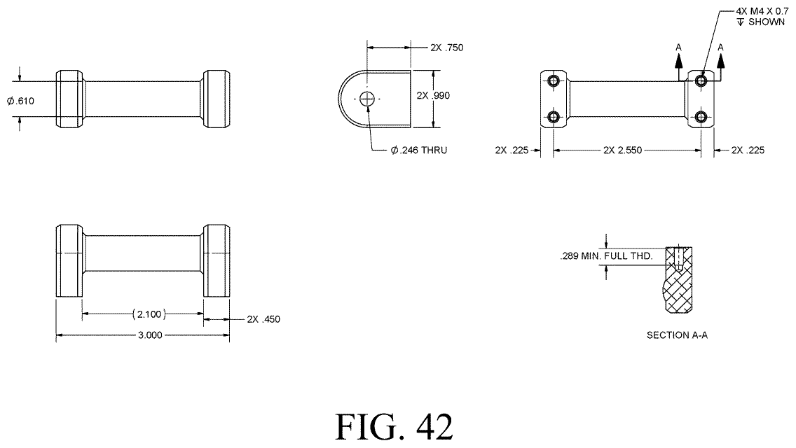

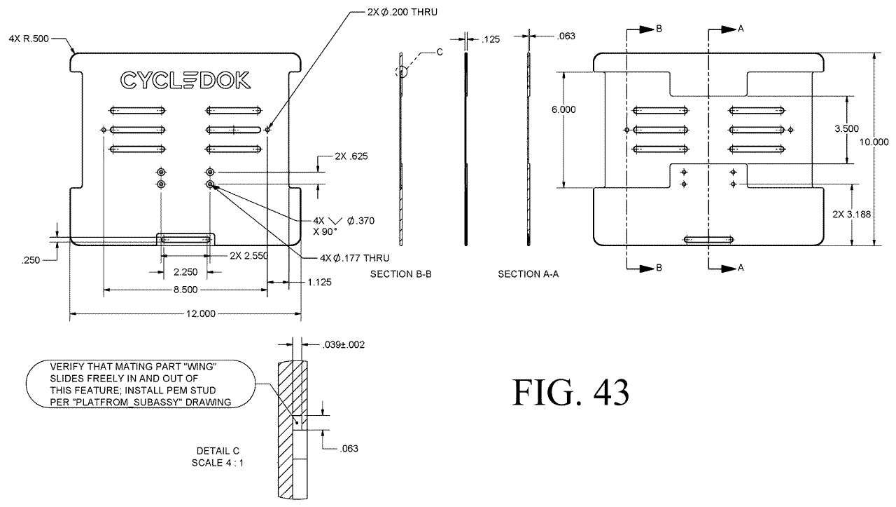

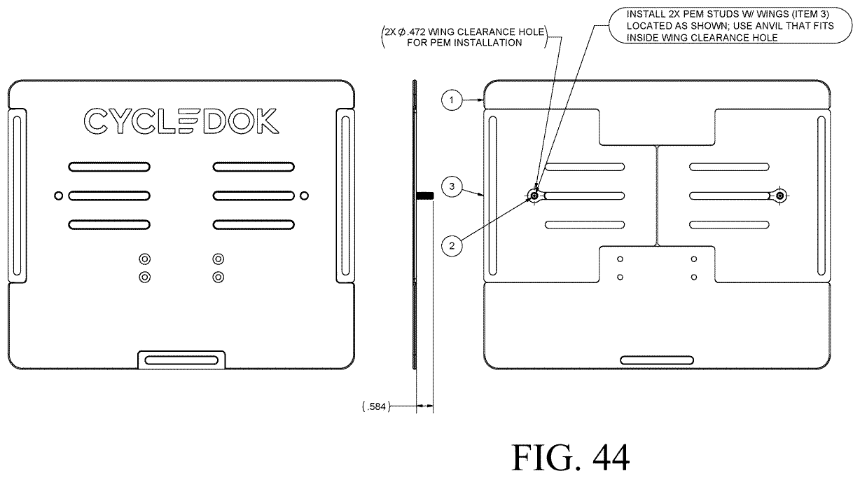

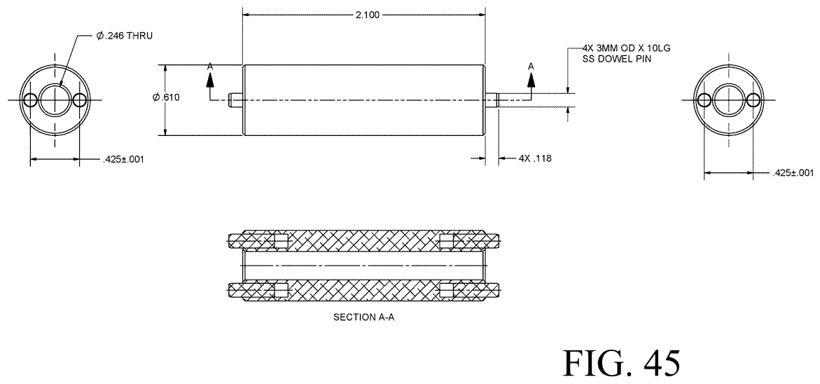

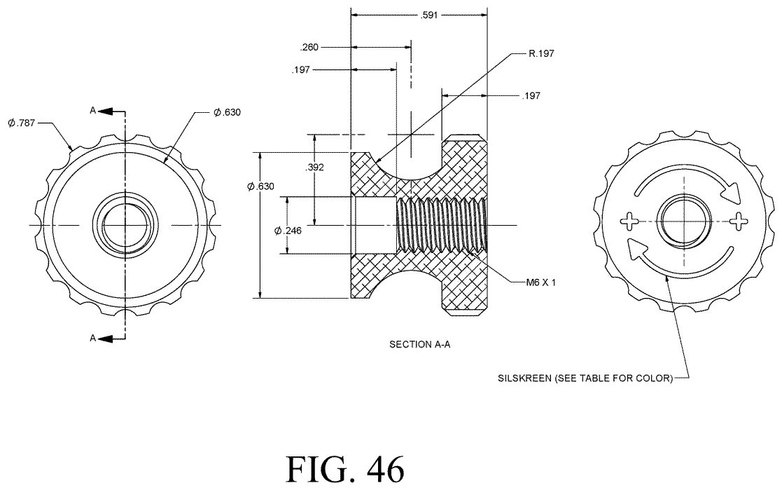

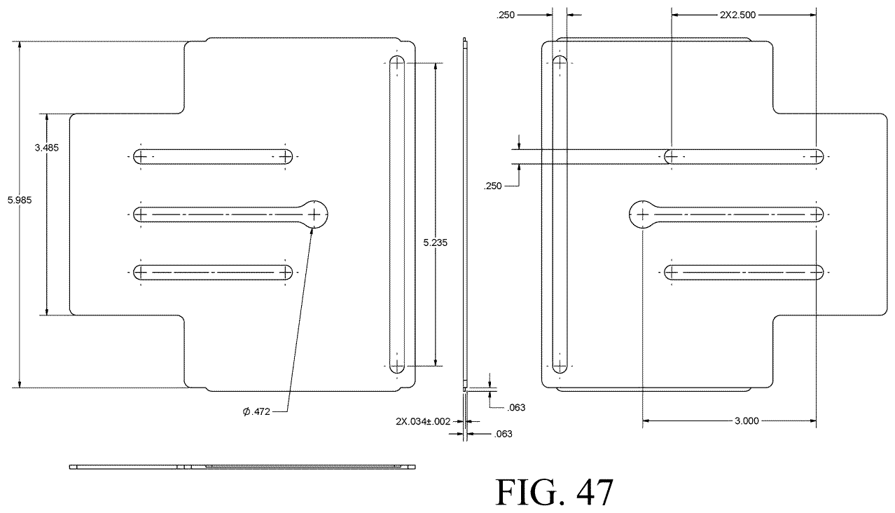

FIG. 42 displays a pivot mount that is part of one embodiment of the present invention. The pivot mount raises the platform attached to the spacer and the left and right pivot arms. FIG. 43 displays a platform that is part of one embodiment of the present invention. The platform is where electronic devices are placed and held, such that the user can use those electronic devices while cycling on a stationary bike. FIG. 44 displays a platform subassy that is part of one embodiment of the present invention. This displays the bottom of the platform. FIG. 45 displays a spacer that is part of one embodiment of the present invention. The spacer is a cylinder that connects the 2 bar clamps, and a screw goes through the whole cylinder as in a shaft. There is another cylinder/shaft below the tray connecting both pivot arms. FIG. 46 displays a thumb screw that is part of one embodiment of the present invention. The thumb screw adjusts the keeper(s) for wider objects, such as laptops and tablets, that exceed the platform's width. FIG. 47 displays a wing that is part of one embodiment of the present invention. The wings are horizontally expanding sides of the platform.

The following are several embodiments, and any embodiment may be combined with one or more embodiments. In one embodiment, there is a mount for a laptop computer on a stationary bike, comprising: a left bar clamp and a right bar clamp; wherein the left bar clamp and right bar clamp attach to handlebars on a stationary bike; wherein the mount is made of high-strength composite material; wherein the mount is adjustable in regards to changing size to fit different electronic devices; wherein the mount has a platform that can hold electronic devices; wherein the platform can move horizontally; wherein the platform can adjust its width; wherein the platform has a vertical catch so as to hold an electronic device on top; wherein the platform has horizontal catches on left and right sides, so as to hold an electronic device on the left and right sides; wherein the mount can change angles so as to be easy to view by a user; wherein the mount may be secured to either road or mountain bike handlebars; and wherein the platform can be tightened on an electronic device so as to hold the electronic device such that the electronic device does not fall while a user rides on the stationary bike.

In another embodiment of the invention, the mount further comprises: wherein the mount has an alternative friction joint; wherein the alternative friction joint produces constant torque; and wherein the alternative friction joint is placed in a middle of the mount. In another embodiment of the invention, the mount further comprises: wherein the mount has 2 pivot arms; wherein the mount can be adjusted in terms of tilt and angle by loosening and tightening thumbscrews on the 2 pivot arms; and wherein the thumbscrews can also be loosened to move the horizontally moving catch so that a user can securely connect a wider electronic device to the platform. In another embodiment of the invention, the mount further comprises: wherein the mount may be moved 360 degrees, so that the platform can be visible from any angle. In another embodiment of the invention, the mount further comprises: wherein the mount's vertical and horizontal catches are removable. In another embodiment of the invention, the mount further comprises: wherein the horizontal catches can be removed from the left and right sides of the mount, and placed on an inboard closer to a middle section of the mount, in order to better fit smaller devices including tablets and smartphones. In another embodiment of the invention, the mount further comprises: wherein the horizontal catches may be moved up and down the mount. In another embodiment of the invention, the mount further comprises: wherein the mount is made of aluminum. In another embodiment of the invention, the mount further comprises: wherein the aluminum is anodized. In another embodiment of the invention, the mount further comprises: wherein the mount has an adapter that a user can use to secure the mount to smaller handlebars than normal size. In another embodiment of the invention, the mount further comprises: wherein the left bar clamp and right bar clamp are made of stainless steel.

In another embodiment of the invention, the mount further comprises: wherein the keeper is made of anodized aluminum; wherein the 3 pivots are made of anodized aluminum; wherein the platform is made of anodized aluminum; wherein the spacer is made of anodized aluminum; wherein the grommet hex driver is made of urethane; wherein there is a thumb screw; wherein the thumb screw is made of anodized aluminum; wherein there is a wing; and wherein the wing is made of anodized aluminum.

In another embodiment of the present invention, there is a mount for a laptop computer on a stationary bike, comprising: a left bar clamp and a right bar clamp; wherein the left bar clamp and right bar clamp attach to handlebars on a stationary bike; wherein the mount is made of high-strength composite material; wherein the mount is adjustable in regards to changing size to fit different electronic devices; wherein the mount has a platform that can hold electronic devices; wherein the platform can move horizontally; wherein the platform can adjust its width; wherein the platform has a vertical catch so as to hold an electronic device on top; wherein the platform has horizontal catches on left and right sides, so as to hold an electronic device on the left and right sides; wherein the mount can change angles so as to be easy to view by a user; wherein the mount may be secured to either road or mountain bike handlebars; wherein the mount can be tightened on an electronic device so as to hold the electronic device such that the electronic device does not fall while a user rides on the stationary bike; and wherein the mount has 2 pivot arms.

In another embodiment of the present invention, the mount further comprises: wherein there is an adapter; wherein the adapter is an inner cover between the left bar clamp and right bar clamp; and wherein the adapter allows a user to secure the mount to a smaller diameter set of handlebars. In another embodiment of the present invention, the mount further comprises: wherein the mount has a spacer; wherein the spacer is a cylinder that connects the left bar clamp and right bar clamp; wherein a screw goes through the cylinder like a shaft. In another embodiment of the present invention, the mount further comprises: wherein the pivot arms are made of anodized aluminum; wherein the platform is made of anodized aluminum; wherein the spacer is made of anodized aluminum; wherein the grommet hex driver is made of urethane; wherein the thumb screw is made of anodized aluminum; and wherein the wing is made of anodized aluminum.

In another embodiment of the present invention, the mount for a laptop computer on a stationary bike, comprising: a left bar clamp and a right bar clamp; wherein the left bar clamp and right bar clamp attach to handlebars on a stationary bike; wherein the mount is made of high-strength composite material; wherein the mount has a platform that can hold electronic devices; wherein the mount can change angles so as to be easy to view by a user; wherein the mount may be secured to either road or mountain bike handlebars. In another embodiment of the present invention, the mount further comprises: wherein the mount may be moved 360 degrees, so that the platform can be visible from any angle. In another embodiment of the present invention, the mount further comprises: wherein the mount has 2 pivot arms; wherein the mount can be adjusted in terms of tilt and angle by loosening and tightening thumbscrews on the 2 pivot arms; and wherein the thumbscrews can also be loosened to move the horizontally moving catch so that a user can securely connect a wider electronic device to the platform. In another embodiment of the present invention, the mount further comprises: wherein the mount is made of aluminum.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

1. A mount for a laptop computer on a stationary bike, comprising:
a left bar clamp and a right bar clamp;
wherein the left bar clamp and right bar clamp attach to handlebars on a stationary bike;
wherein the mount is made of high-strength composite material;
wherein the mount is adjustable in regards to changing size to fit different electronic devices;
wherein the mount has a platform that can hold electronic devices;
wherein the platform can move horizontally;
wherein the platform can adjust its width;
wherein the platform has a vertical catch so as to hold an electronic device on top;
wherein the platform has horizontal catches on left and right sides, so as to hold an electronic device on the left and right sides;
wherein the mount can change angles so as to be easy to view by a user;
wherein the mount may be secured to either road or mountain bike handlebars; and
wherein the platform can be tightened on an electronic device so as to hold the electronic device such that the electronic device does not fall while a user rides on the stationary bike.

2. The mount of claim 1, further comprising:
wherein the mount has an alternative friction joint;
wherein the alternative friction joint produces constant torque; and
wherein the alternative friction joint is placed in a middle of the mount.

3. The mount of claim 1, further comprising:
wherein the mount has 2 pivot arms;
wherein the mount can be adjusted in terms of tilt and angle by loosening and tightening thumbscrews on the 2 pivot arms; and
wherein the thumbscrews can also be loosened to move the horizontally moving catch so that a user can securely connect a wider electronic device to the platform.

4. The mount of claim 1, further comprising:
wherein the mount may be moved 360 degrees, so that the platform can be visible from any angle.

5. The mount of claim 1, further comprising:
wherein the vertical and horizontal catches are removable.

6. The mount of claim 1, further comprising:
wherein the horizontal catches can be removed from the left and right sides of the mount, and placed on an inboard closer to a middle section of the mount, in order to better fit smaller devices including tablets and smartphones.

7. The mount of claim 1, further comprising:
wherein the horizontal catches may be moved up and down the mount.

8. The mount of claim 1, further comprising:
wherein the mount is made of aluminum.

9. The mount of claim 9, further comprising:
wherein the aluminum is anodized.

10. The mount of claim 1, further comprising:
wherein the mount has an adapter that a user can use to secure the mount to smaller handlebars than normal size.

11. The mount of claim 1, further comprising:
wherein the left bar clamp and right bar clamp are made of stainless steel.

12. The mount of claim 1, further comprising:
wherein the keeper is made of anodized aluminum;
wherein the 3 pivots are made of anodized aluminum;
wherein the platform is made of anodized aluminum;
wherein the spacer is made of anodized aluminum;
wherein the grommet hex driver is made of urethane;
wherein there is a thumb screw;
wherein the thumb screw is made of anodized aluminum;
wherein there is a wing; and
wherein the wing is made of anodized aluminum.

13. A mount for a laptop computer on a stationary bike, comprising:
a left bar clamp and a right bar clamp;
wherein the left bar clamp and right bar clamp attach to handlebars on a stationary bike;
wherein the mount is made of high-strength composite material;
wherein the mount is adjustable in regards to changing size to fit different electronic devices;
wherein the mount has a platform that can hold electronic devices;
wherein the platform can move horizontally;
wherein the platform can adjust its width;
wherein the platform has a vertical catch so as to hold an electronic device on top;
wherein the platform has horizontal catches on left and right sides, so as to hold an electronic device on the left and right sides;
wherein the mount can change angles so as to be easy to view by a user;
wherein the mount may be secured to either road or mountain bike handlebars;
wherein the mount can be tightened on an electronic device so as to hold the electronic device such that the electronic device does not fall while a user rides on the stationary bike; and
wherein the mount has 2 pivot arms.

14. The mount of claim 13, further comprising:
wherein there is an adapter;
wherein the adapter is an inner cover between the left bar clamp and right bar clamp; and
wherein the adapter allows a user to secure the mount to a smaller diameter set of handlebars.

15. The mount of claim 13, further comprising:
wherein the mount has a spacer;
wherein the spacer is a cylinder that connects the left bar clamp and right bar clamp;
wherein a screw goes through the cylinder like a shaft.

16. The mount of claim 13, further comprising:
wherein the pivot arms are made of anodized aluminum;
wherein the platform is made of anodized aluminum;
wherein the spacer is made of anodized aluminum;
Wherein the grommet hex driver is made of urethane;
Wherein the thumb screw is made of anodized aluminum; and
Wherein the wing is made of anodized aluminum.

17. A mount for a laptop computer on a stationary bike, comprising:
a left bar clamp and a right bar clamp;
wherein the left bar clamp and right bar clamp attach to handlebars on a stationary bike;
wherein the mount is made of high-strength composite material;
wherein the mount has a platform that can hold electronic devices;
wherein the mount can change angles so as to be easy to view by a user;
wherein the mount may be secured to either road or mountain bike handlebars.

18. The mount of claim 17, further comprising:
wherein the mount may be moved 360 degrees, so that the platform can be visible from any angle.

19. The mount of claim 17, further comprising:
wherein the mount has 2 pivot arms;
wherein the mount can be adjusted in terms of tilt and angle by loosening and tightening thumbscrews on the 2 pivot arms; and
wherein the thumbscrews can also be loosened to move the horizontally moving catch so that a user can securely connect a wider electronic device to the platform.

20. The mount of claim 17, further comprising:
wherein the mount is made of aluminum.
